(19) United States
(12) Patent Application Publication
(10) Pub. No.: US 2016/0350691 A1
(43) Pub. Date: Dec. 1, 2016

(54) Task Quality Assurance

(71) Applicant: TaskEasy, Inc., Walnut, CA (US)

(72) Inventors: Ken R. Davis, Salt Lake City, UT (US); Fraser M. Smith, Walnut, CA (US)

(21) Appl. No.: 15/165,906

(22) Filed: May 26, 2016

Related U.S. Application Data
(60) Provisional application No. 62/166,532, filed on May 26, 2015.

(51) Int. Cl. G06Q 10/06; G06Q 50/10

(52) U.S. Cl. CPC G06Q 10/06395; G06Q 50/10

(57) ABSTRACT

A technology is described for sampling tasks for quality assurance. An example method may include managing a plurality of tasks assigned to and performed by service providers for customers. A sampling rate may be assigned to the plurality of tasks based on task details associated with a task, such that different tasks may have different sampling rates. The plurality of tasks may then be sampled according to the sampling rate assigned to the plurality of tasks, and a determination may be made whether to review a sampled task for quality assurance based on task analysis data after completion of the individual task.

### BACKGROUND

Many goods may be purchased in a commoditized way. A consumer can have certain criteria when deciding to purchase goods, and if the goods meet the desired criteria, then the consumer generally does not care who provides the goods.

Services have traditionally been less commoditized. Rather, services are typically purchased after comparing service providers to one another. For example, service providers may be compared through a bidding process, interviews, and/or online user feedback ratings. Such service provider comparisons may be challenging for a consumer to interpret due the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a diagram illustrating an example system and method for sampling tasks for quality assurance.

FIG. 2 is a block diagram that illustrates an example of a system used to sample tasks for quality assurance.

FIG. 3 illustrates an example of a system used for determining sampling rates for tasks having various attributes.

FIG. 4 is a flowchart illustrating an example method for sampling tasks for quality assurance

FIG. 5 is a flowchart illustrating an example method for providing quality assurance of tasks.

FIG. 6 is block diagram illustrating an example of a computing device that may be used for sampling tasks for quality assurance.

### DETAILED DESCRIPTION

A technology is described for sampling task completion data for tasks performed for a customer by a service provider in order to evaluate the task completion data for quality assurance. In one example configuration, a sampling rate may be used to select task completion data for a task. The sampling rate may specify that a percentage (e.g., 1%, 5%, 25%, 50%, 65%, etc.) of completed tasks are to be sampled for quality assurance. Illustratively, the sampling rate may be used to sample a general pool of tasks, or the sampling rate may be associated with a task profile (e.g., a task type), where tasks matching the task profile are sampled according to the sample rate. A sampling rate may be set based on a probability that task completion data associated with a task includes anomalous data. Anomalous data in task completion data may indicate a quality assurance issue in how a task was performed. Completed task data selected for sampling according to the sampling rate may then be analyzed to identify anomalous data by applying quality assurance rules used to detect anomalous data in the completed task data.

Tasks may be commoditized services that a customer may purchase, which may then be assigned and/or sold to a service provider to perform. For example, a task seller or an advertiser may advertise to a customer a lawn mowing service at a fixed price. The customer may purchase the lawn mowing service from the task seller or advertiser, and the task seller may then assign the lawn mowing task to a service provider whose trade is to mow lawns. Service providers may include vendors, contractors, or any person or entity that may perform a service for a customer. Customers that purchase a service may do so without much deference as to who performs the service. Rather, a customer's concern may be that the service is performed by a service provider according to certain task guidelines. For example, a customer who may purchase a lawn mowing task may not care who actually performs the lawn mowing service, as long as the service is performed according to the guidelines that the customer requested or expects. In a commoditized services market, a challenge may be performing quality assurance of assigned tasks using task completion data provided by: a service provider who performed a task, a customer who purchased the task, and/or data gathered by a computing device (e.g., smartphone, tablet or like device) before, during and after the task was performed.

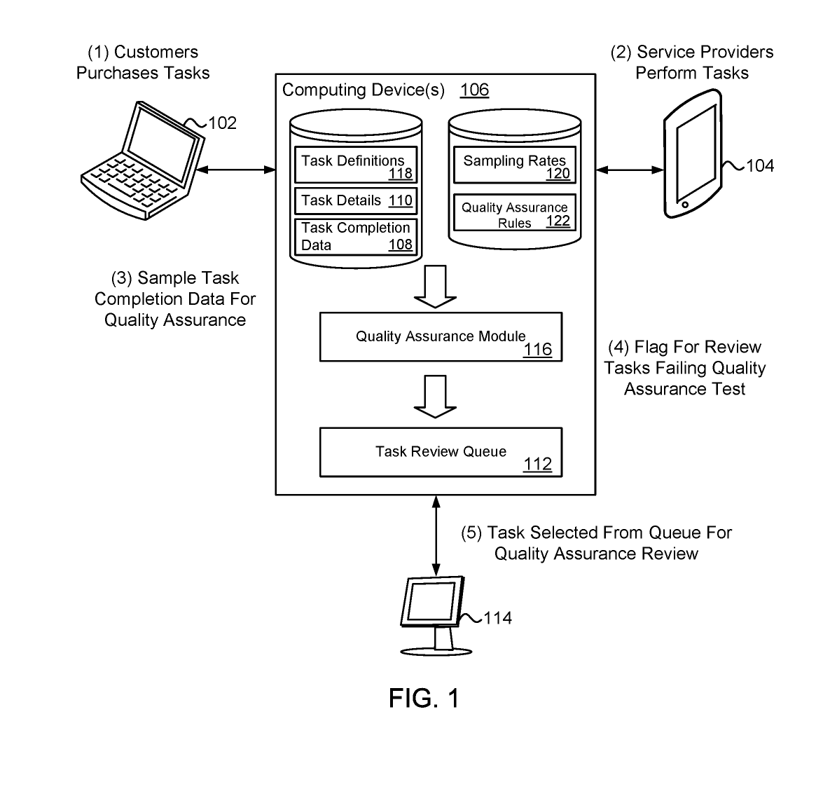

FIG. 1 illustrates a high level example of a system and a method that may be used to perform quality assurance for tasks using a quality assurance standard. The system may include one or more computing devices 106 having various data stores used to store task definitions 118, task details 110, task completion data 108, sampling rates 120 and quality assurance rules 122. The computing device 106 may be used to execute a quality assurance module 116 and a may include a task review queue 112 in which tasks flagged for review may be placed.

A number of client devices may be in communication with the computing device(s) 106 by way of a communications network. For example, a customer client device 102 may allow a customer to access the computing device 106 via a customer interface to view and purchase tasks from a task seller (e.g., a task broker), as well as provide task completion data 108 to the task seller for a task performed by a service provider. A service provider client device 104 may allow a service provider to access the computing device 106 via a service provider interface in order to view tasks that have been assigned to and/or purchased by the service provider, and to provide task completion data 108 to the task seller using the computing device 106. A quality assurance client device 114 may be used by a quality assurance administrator to access and review tasks that have been placed in a task review queue 112 via a quality assurance interface. A graphical user interface can be provided to the various users of the client devices 102, 104 and 114 in order to allow the users access to respective task information and to submit and view task completion data for a task.

In one example configuration, a customer using a customer client device 102 may purchase a task from a task seller. A service provider may then be selected from a pool of service providers by the task seller and the task may be assigned to the service provider. Alternatively, a pool of service providers may bid on the task and the winning bidder may then be assigned to perform the task. In another example, the task purchased by the customer may be listed in a task listing and an interested service provider may purchase the right to perform the task. Having acquired the right to perform the task from the task seller, the service provider may then proceed to the physical location and begin performance.

Once task performance has begun, task completion data 108 may be collected and transmitted to the computing device 106. Task completion data 108 may include details related to task performance. For instance, task completion data 108 may include, but is not limited to: a beginning timestamp, an ending timestamp, a travel time to the task location, GPS (Global Positioning Satellite) data, photographs, a service provider review, a customer review, a third-party review, a materials list/invoice, etc. The task completion data 108 may be submitted by a service provider, a customer and/or a third-party. For example, a service provider, a customer or a third-party may submit task completion data 108 before, during and after a task is performed.

In a case where task completion data 108 may be submitted by a service provider, a service provider client device 104 may collect and transmit the task completion data 108 to the computing device 106. For example, a service provider client device 104 equipped with a GPS module may interface with the computing device 106 sending location data to the computing device 106 as a task is being performed by a service provider. As a result, the location of a service provider and the time spent at location providing a service can be tracked (via the service provider client device 104) using the GPS module to create a task start time, a task end time, as well as times in-between and the location data can be transmitted to the computing device 106 by way of a cellular network.

Task completion data 108 for completed tasks submitted to the computing device 106 may be sampled for quality assurance. Namely, completed tasks performed by service providers can be reviewed for quality assurance to determine whether the task was completed in accordance with task guidelines for the task. Task guidelines for a task may be included in task details 110 that specify where and how a task is to be performed. For instance, task details for a lawn mowing task may include a location where the task is to be performed, a time when the task is to be started, a period of time in which the task is to be completed, instructions or guidelines specific to the lawn mowing task (e.g., lawn locations, cut grass length, lawn pattern, lawn clipping disposal, trimming instructions, blowing cuttings, etc.).

Identifying which tasks are to be sampled for quality assurance may be determined using a sampling rate 120 associated with a task category or task attribute. The sampling rate 120 may specify that a percentage of tasks within a task category, or tasks having a task attribute, are sampled at a specific rate for quality assurance. Illustratively, a predetermined percentage of tasks within a lawn mowing task category may be sampled as determined by the sampling rate 120 to assess whether the lawn mowing task was completed according to task details associated with each lawn mowing task. Thus, for example, a sampling rate 120 for lawn mowing tasks may state that 30%, 45%, 65% or some other percentage of lawn mowing tasks are sampled for quality assurance. Some task categories or task attributes may have higher error rates or anomaly rates than other task categories or task attributes. Thus, different quality assurance rates may be applied to the varying task categories or task attributes.

In one example configuration, a sampling rate 120 assigned to a task category or task attribute may be based on a probability of an anomaly being present in task completion data 108 associated with the task category or task attribute. Examples of task categories may include, but are not limited to, lawn mowing, snow removal, pool maintenance, etc. Examples of task attributes may include, but are not limited to, a service provider assigned to a task, a geographical location of a task, a task customer, or some other attribute related to a task. A sampling rate 120 may be assigned to one or more task categories and task attributes and the task categories and task attributes may be sampled at the sample rate 120 assigned. As an illustration, tasks having a task category (e.g., snow removal) with an assigned sample rate 120 (e.g., 20%) may be sampled according to the assigned sample rate 120. Tasks having a task attribute (e.g., an assigned service provider) with an assigned sample rate 120 (e.g., 80%) may be sampled based on the separately assigned sample rate 120 for the task attribute.

A quality assurance module 116 may be used to perform quality assurance for sampled tasks. In one example, performing quality assurance for a task may include selecting a task category or a task attribute having an assigned sample rate 120 and selecting a percentage of completed tasks associated with the task category or task attribute according to the percentage specified by the sample rate 120. Task completion data 108 for the tasks selected may be retrieved and using quality assurance rules 122, the task completion data 108 may be analyzed for anomalous data indicating quality assurance issues in performance of the tasks. Anomalous data may be variances in task completion data 108 that are discovered when the task completion data 108 for a task is compared to task details 110 for the task. For example, comparing task completion data 108 for a task with task details 110 for the task may reveal various inconsistencies in how the task was performed, as opposed to how the task details 110 specify how the task was to be performed. As a specific example, a task for snow removal may include task details 110 that include a task address, a start time, areas designated for snow removal and application of an ice removal product to the designated areas. Task completion data 108 submitted by a service provider and/or a customer may indicate whether the service provider showed up to the task address, the time that the task was started, whether snow was removed from all areas designated for snow removal, and whether an ice removal product was applied. In a case where ice removal product was not applied to designated areas, comparing the task details 110 with the task completion data 108 may reveal that the service provider failed to apply the ice removal product.

A variance (i.e., an anomaly) between task completion data 108 and task details 110 for a task may cause the task to be flagged for a quality assurance review. Flagging a task satisfying quality assurance rules 122 (e.g., rules used to compare task completion data 108 with task details 110) may cause a reference to the task to be placed in a task review queue 112. The task may then be reviewed using machine analysis using a quality assurance standard when the respective task reference is selected from the task review queue 112. A quality assurance standard may comprise a combination of task details 110 and task completion guidelines. In one example configuration, a task review queue 112 may include references to tasks satisfying both anomalous and non-anomalous quality assurance rules 122. Anomalous quality assurance rules 122 may be more stringent as compared to non-anomalous quality assurance rules 122. For example, the parameters of anomalous quality assurance rules 122 may be broad so that a greater number of attributes for a task are analyzed as compared to a number of attributes analyzed for a task using non-anomalous quality assurance rules 122.

A quality assurance practice may call for sampling all completed tasks by selecting random tasks and placing references to the tasks in the task review queue 112. As a result, the task may be queued for review among a number of tasks flagged as satisfying the anomalous or non-anomalous quality assurance rules 122. Because tasks 118 flagged as satisfying anomalous quality assurance rules 122 may be queued with tasks satisfying non-anomalous quality assurance rules 122, the tasks may be ranked in the task review queue 112 so that, for example, a reference to tasks flagged as satisfying anomalous quality assurance rules 122 may be placed at the front of the task review queue 112, resulting in the tasks being reviewed before tasks satisfying non-anomalous quality assurance rules 122 because the tasks satisfying the anomalous sampling rules 122 are more likely to have problems that are more serious in nature.

Alternatively, review of the tasks may also be performed by a quality assurance representative who may select a task from the task review queue 112 and manually review task completion data 108 for the task. Namely, the quality assurance representative may review the task completion data 108 using the quality assurance standard described above. After reviewing the task completion data 108, a determination may then be made whether to request physical inspection of the task completion (e.g., visit the job site). When requested, a physical inspection may be performed by a task manager, an inspection service provider, or some other person assigned to perform an inspection of the task completion.

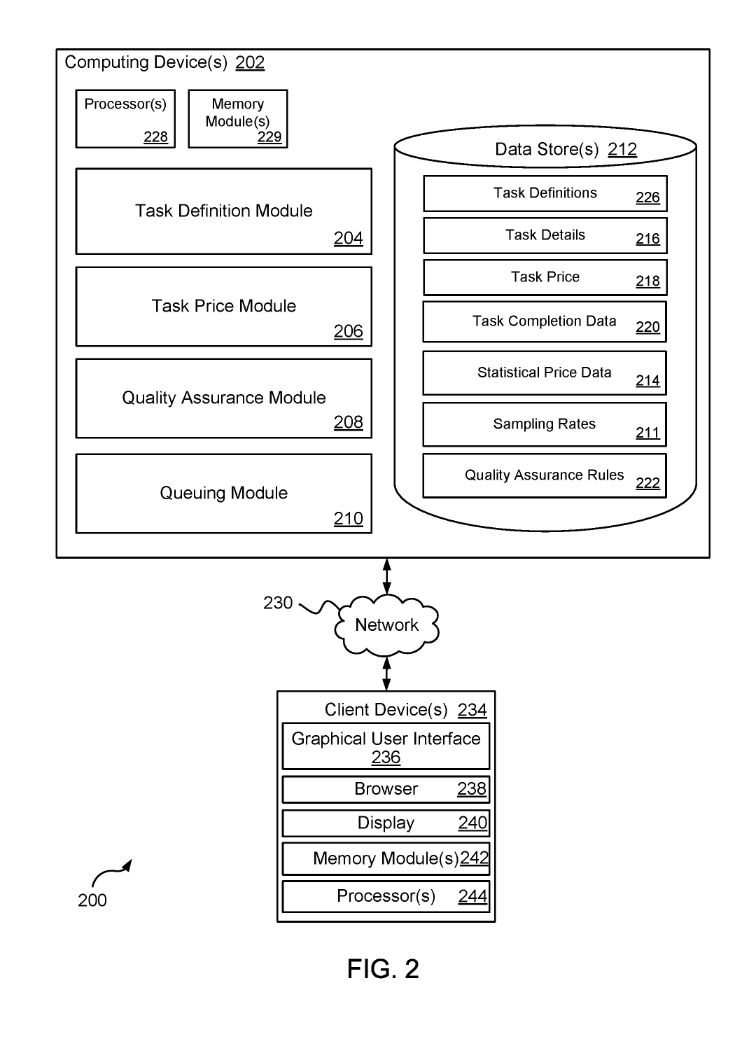

FIG. 2 illustrates an example of various components of a system 200 on which the present technology may be executed. In one example configuration, the system 200 may include a computing device 202 that may be in communication with a number of client devices 234 by way of a communications network 230. The computing device 202 may contain a data store 212 that is accessible to the computing device 202. Various data may be stored in the data store 212 relating to tasks and performing quality assurance for tasks. The computing device 202 may also contain a number of modules that may be used to perform the operations for the technology. The modules may include a task definition module 204 used to identify a task definition 226 for a task, a task price module 206 used to set a task price 218 for a task, a quality assurance module 208 used to perform quality assurance for a task, a queuing module 210 that queues tasks for quality assurance review, as well as other services, processes, systems, engines, or functionality not discussed in detail herein.

In one example configuration, using the task definition module 204, a task definition 226 for a task may be identified and retrieved from a data store 212. The task definition 226 may identify a task and may be associated with other task data, such as task details 216, task price 218 and task completion data 220. Examples of task details 216 may include, but are not limited to, a task type (e.g., lawn care, snow removal, handyman services, etc.), a task location (e.g., a physical address, a designated area of a property where the task is to be performed), task instructions (e.g., a start time, customer instructions), an expected task duration time, customer information or any other information related to a task. Based on the task details 216 for a task and statistical price data 214 related to the task, the task price module 206 may be used to set a task price 218. The task price 218, in one example, may be the price that a customer pays in order to have the task performed by a service provider. In some cases, a portion of the task price 218 paid by the customer may be paid to a service provider who performs the task.

Statistical price data 214 used in determining a task price 218 may be based on historical price information for a category of tasks collected over a period of time. Illustratively, the historical price information for a category of tasks may be averaged to determine a statistical price for the category of tasks. In one example, statistical price data 214 may be based on a geographical location where the task is to be performed. For example, a price of a task may vary between cities due to differences in various city attributes between cities that have an influence on performing a task, such as road infrastructure that may affect travel times to a task location. Using the task price module 206, task details 216 for a task may be obtained (i.e., via the task definition module 204) and based on the task details 216, related statistical price data 214 may be identified, which then may be used to set a task price 218.

Having set a task price 218 for a task, a service provider may then be assigned the task. When performing the task, information related to task performance (e.g., task completion data 220) can be collected and saved to a data store 212. As noted earlier, task completion data 220 can include data, such as, a beginning timestamp, an ending timestamp, GPS (Global Positioning Satellite) data, photographs, a travel time to a task location, a service provider review, a customer review, a third-party review, a materials list/invoice, etc. Task completion data 220 collected for a task may be transmitted from a service provider's client device 234 to the computing device 202.

As a specific example of how task completion data 220 may be collected for a lawn care task, a service provider performing the task may be equipped with a mobile device (e.g., a client device 234), such as a smartphone, a tablet computer or a laptop computer. The mobile device may transmit task completion data 220 to the computing device 202 over a communications network 230 as the task is being performed, or the task completion data 220 may be transmitted to the computing device 202 at a later time via a manual process (e.g., a manual upload). When leaving for the task location, using the mobile device, the service provider may log a departure time. The mobile device may include a GPS module capable of tracking the service provider's route to the task location, which may be transmitted to the computing device 202. Upon reaching the task location, the service provider can then log a task start time, as well as any other information related to beginning the lawn care task (e.g., a preliminary inspection of the lawn, task detail discrepancies, photographs of the lawn, etc.). As the service provider performs the lawn care task, the service provider may carry the mobile device containing the GPS module, which may track the progress of the service provider as the lawn care task is performed. Upon completing the task, the service provider can then log a finish time, add notes related to performing the task, take photographs of the completed lawn care area and/or obtain information from the customer (e.g., a customer survey). The task completion data 220 collected above may be transmitted to the computing device 202 and stored in a data store 212 as the task completion data 220 is collected.

In one example, a customer may provide a notification regarding fulfillment of task requirements by a service provider after a task has been completed, which may be included in the task completion data 220. The customer may provide the notification using a customer's client device 234, for example. Accordingly, the notification may be kept private from the service provider who performed the task. In another example, a customer may provide notifications via the customer's client device 234 regarding the fulfillment of task details by a service provider at any time during performance of a task, which may be sent to the computing device 202 and made part of the task completion data 220.

Task completion data 220 collected for a number of tasks performed by various service providers may be stored in a data store 212 on the computing device 202. The quality assurance module 208 may be used to receive task completion data 220 for a plurality of tasks and flag tasks selected at the defined sampling rate 211 for a task category that satisfy quality assurance rules 222.

Various methods may be used to perform quality assurance of task completion data 220. In one example, a sampling rate 211 may determine a percentage of tasks in a task category that are provided to the quality assurance module 208. In another example, quality assurance may be performed for every task having task completion data 220. The quality assurance module 208 may be used to analyze the task completion data 220 and identify task completion data 220 that satisfies various quality assurance rules 222.

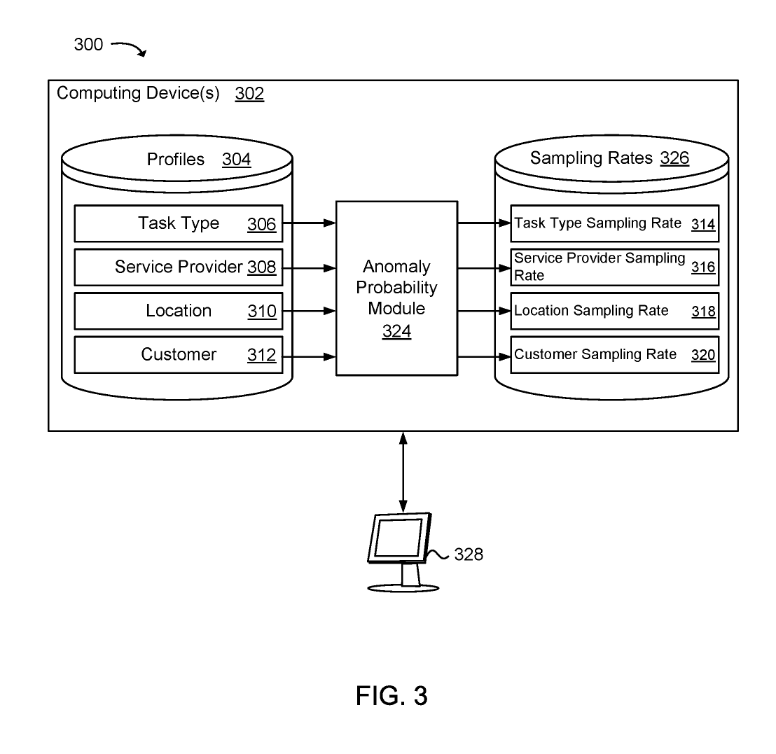

In one example configuration, a sampling rate 211 may be assigned based on anomalous quality assurance rules 222 or non-anomalous quality assurance rules 222. A sampling rate 211 based on anomalous quality assurance rules 222 may be assigned to tasks having a particular task profile or task attribute. In determining the sampling rate 211 for a task based on anomalous quality assurance rules 222, a probability may be calculated that the task completion data 220 for the task includes anomalous data indicating a problem in the way the task was performed. As a result, those tasks having the task profile or task attribute may be subject to a higher sampling rate than tasks subject to a sampling rate based on non-anomalous quality assurance rules 222. Illustratively, a sampling rate 211 based on non-anomalous quality assurance rules 222 may be used to identify a subset of tasks from a general pool of tasks based on some non-anomalous factor, such as a predetermined sampling rate 211 applied to all tasks within the pool of tasks irrespective of any task profile or attribute that a task may have. Non-anomalous quality assurance rules 222 will be discussed in greater detail below in relation to FIG. 3.

Task completion data 220 for tasks selected using a sampling rate 211 may be analyzed based either on anomalous quality assurance rules 222 or non-anomalous quality assurance rules 222 and task completion data 220 containing anomalous data that indicates an issue in the way the task was performed may be flagged. For instance, anomalous data in the task completion data 220 for a task may be detected by comparing the task completion data 220 with task details 216 for the task. Variances between the task completion data 220 and the task details 216 may cause the task to be flagged for further review. As an illustration, a quality assurance rule 222 may be configured to detect anomalous data in task completion data 220 associated with a specific type of task, such as a pest control task type. For example, the quality assurance rule 222 may be configured to detect gaps in the application of a pest control treatment by comparing task completion data 220 submitted by a service provider (e.g., information about areas treated by the service provider) with task details 216 (e.g., information about areas specified by a customer for treatment) for the task. In a case where gaps in the application of the pest control treatment are detected, the task may be flagged for review.

In one example configuration, a service provider may have the ability to provide a notification via a mobile device regarding the accuracy of the task details 216 for a task prior to performing the task. For example, upon arriving at the task location, a service provider may inspect the conditions of the worksite and may make a determination whether the task details 216 correlate with the task location conditions, and if not, provide a notification. As a result, task details 216 for the task may be updated to reflect the actual conditions of the task location, or the task completion data 220 for the task may be made exempt from being analyzed because the task details 216 may no longer provide a reliable base in which a comparison of the task completion data 220 can be made. In some cases, a notification by a service provider that the task details 216 may not be accurate may cause the task to be automatically flagged for quality assurance review due to the lack of reliable task details 216.

The queuing module 210 may be used to queue tasks for review by, for example, a quality assurance associate when the tasks are flagged as satisfying the anomalous or non-anomalous quality assurance rules 222. A reference to the tasks may be placed in a task review queue. When selecting task to review, a task reference may be selected from the front of the task review queue. In a case where both anomalous and non-anomalous quality assurance rules 222 are being used, tasks flagged as satisfying the anomalous quality assurance rules may be placed in a task review queue with tasks satisfying the non-anomalous quality assurance rules. Because tasks flagged as satisfying anomalous quality assurance rules 222 may need to be reviewed by a quality assurance administrator or associate prior to other tasks, a ranking may be assigned to task references flagged as satisfying the anomalous quality assurance rules that results in placing a task reference in the front of the task review queue. Quality assurance administrators may retrieve task references from the task review queue and perform quality assurance analysis that may include sending a person to the physical location where the task was performed to perform a physical inspection.

A client device 234 used by a service provider performing a task or a customer submitting task related data may include any device capable of sending and receiving data over a communications network 230. A client device 234 may comprise, for example a processor-based system such as a computing device. Such a computing device may contain one or more processors 244, one or more memory modules 242 and a graphical user interface 236. A client device 234 may be a device such as, but not limited to, a desktop computer, laptop or notebook computer, tablet computer, handheld computer, smartphone, or other devices with like capability. The client device 234 may include a browser 238 that may enable the client device 234 to connect to a web service or console providing service related to the technology. The client device 234 may include a display 240, such as a liquid crystal display (LCD) screen, gas plasma-based flat panel display, LCD projector, cathode ray tube (CRT), or other types of display devices, etc.

The various processes and/or other functionality contained on the computing device 202 may be executed on one or more processors 228 that are in communication with one or more memory modules 229 according to various examples. The computing device 202 may be comprised, for example, of a server or any other system providing computing capability. Alternatively, a number of computing devices 202 may be employed that are arranged, for example, in one or more server banks or computer banks or other arrangements. For purposes of convenience, the computing device 202 is referred to in the singular. However, it is understood that a plurality of computing devices 202 may be employed in the various arrangements as described above.

The term “data store” as used herein may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 212 may include storage systems such as a SAN (Storage Area Network), cloud storage network, volatile or non-volatile RAM, optical media, or hard-drive type media. The data store 212 may be representative of a plurality of data stores 212 as can be appreciated.

The communications network 230 may be a wired or a wireless network such as the Internet, a local area network (LAN), wide area network (WAN), wireless local area network (WLAN), or wireless wide area network (WWAN). The WLAN may be implemented using a wireless standard such as Bluetooth or the Institute of Electronics and Electrical Engineers (IEEE) 802.11-2012, 802.11ac, 802.11ad standards, or other WLAN standards. The WWAN may be implemented using a wireless standard such as the IEEE 802.16-2009 or the third generation partnership project (3GPP) long term evolution (LTE) releases 8, 9, 10 or 11. Components utilized for such a system may depend at least in part upon the type of network and/or environment selected. Communication over the network may be enabled by wired or wireless connections and combinations thereof.

FIG. 2 illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, cloud, grid or cluster computing system. An API (Application Programming Interface) may be provided for each module to enable a second module to send requests to and receive output from the first module. Such APIs may also allow third parties to interface with the module and make requests and receive output from the modules. While FIG. 2 illustrates an example of a system that may implement the techniques above, many other similar or different environments are possible. The example environments discussed and illustrated above are merely representative and not limiting.

Moving now to FIG. 3, is a diagram illustrating a system 300 used to determine sampling rates 326 for tasks having a particular attribute. The system 300 may include one or more computing devices 302 that include data stores containing profiles 304 of various task attributes and sampling rates 326 assigned to the various task attributes. Examples of attributes associated with a task may include a task type 306, a service provider 308, a task location 310 and a customer 312. A profile 304 may be created for a task attribute. Illustratively, a profile 304 may be created for various task types 306, such as a lawn service task profile, a snow removal task profile, a pest control task profile, etc. Profiles 304 may be created for other task attributes as well, such as a service provider profile 308 for each service provider who is assigned tasks, a task location profile 310 for a neighborhood, city or state where a task is performed, and a customer profile 312 for a customer who purchases tasks.

A profile 304 may include information related to a task attribute. As an example, a profile of a service provider may contain information that includes the service provider's background and experience, task performance history, service area, equipment owned by the service provider, contractor insurance status, etc. As such, a profile 304 may provide a level of detail of a task attribute that can be used in determining a sampling rate 326 of tasks having the task attribute.

The system 300 may include an anomaly probability module 324 used to determine a probability that a task having a specified attribute was not performed in accordance with task guidelines for the task. In one example configuration, a probability of an anomaly may be determined based on a profile 304. Information included in a profile 304 may be retrieved and used to calculate a probability that a task having the attribute includes task completion data that does not correspond with task details for the task. As an illustration, a task attribute profile 304 for a service provider 308 may include a history of task performance specifying a number of tasks performed successfully and a number of tasks performed unsuccessfully (e.g., an anomalous performance history). Using the task performance history of the service provider, a calculation may be performed that produces a probability that the service provider performed a task unsuccessfully. As another illustration, a task attribute profile 304 for a task location 310 may be used in determining a probability that a task performed within a particular task location was performed unsatisfactorily. For example, geographically defined patterns showing a history of similar tasks that were unsuccessfully performed within a geographic area can be used to calculate a probability that anomalous data exists in task completion data for tasks performed in the geographic area.

After calculating a probability of anomalous data in task completion data for a task based on a task attribute profile 304, a sampling rate 326 for a task having a task attribute may be set. The sampling rate 326 may specify that a predetermined percentage of completed tasks (i.e., task completion data for the tasks) are sampled to determine whether anomalous data exists within the task completion data, thereby indicating a quality assurance issue in the way the task was performed. In one example, a sampling rate 326 may be set for task attribute profiles 304 for which an anomaly probability was calculated. Thus, based on the example illustrated in FIG. 3, sample rates may include task type sampling rates 314, service provider sampling rates 316, location sampling rates 318 and customer sampling rates 320. In one example, a sampling rate 326 set for a task attribute may correspond to an anomaly probability calculated for the task attribute. For instance, where a high probability exists that a task having a certain attribute will have task completion data that includes anomalous data, a sampling rate 326 assigned to the task attribute may be set to a high percentage. As a specific example, where a task type 306, such as pest control has been determined to have a high probability that the task was performed unsuccessfully, then the task type sampling rate 314 for pest control may be set to 55%, 70%, 80% or some other high sampling rate.

In one example, a user 328 (e.g., a quality assurance associate) may be provided the ability to set sampling rates 326 and/or adjust sampling rates 326 associated with various task attributes. An API, graphical user interface (GUI) or other interface may allow a user 328 to view task attribute profiles 304 and assign a sampling rate 326 to a task attribute. As an illustration, using a client device, a user 328 may view a profile for a service provider 308 in order to make a determination of the service provider's ability to perform a task. For instance, the user 328 may view a service provider's task performance history, view whether the service provider has insurance and any other available information that can be used to determine a reliability of the service provider to accurately perform a task. Based on the profile of the service provider 308, the user 328 may set a service provider sampling rate 316. In a case where the service provider may be a new service provider (e.g., recently affiliated with a task seller), the user 328 may set a service provider sampling rate 316 at 100%, whereas if the service provider has a history of accurately performing assigned tasks, the user 328 may set a service provider sampling rate 316 at a low sampling rate, such as 3% or 5%.

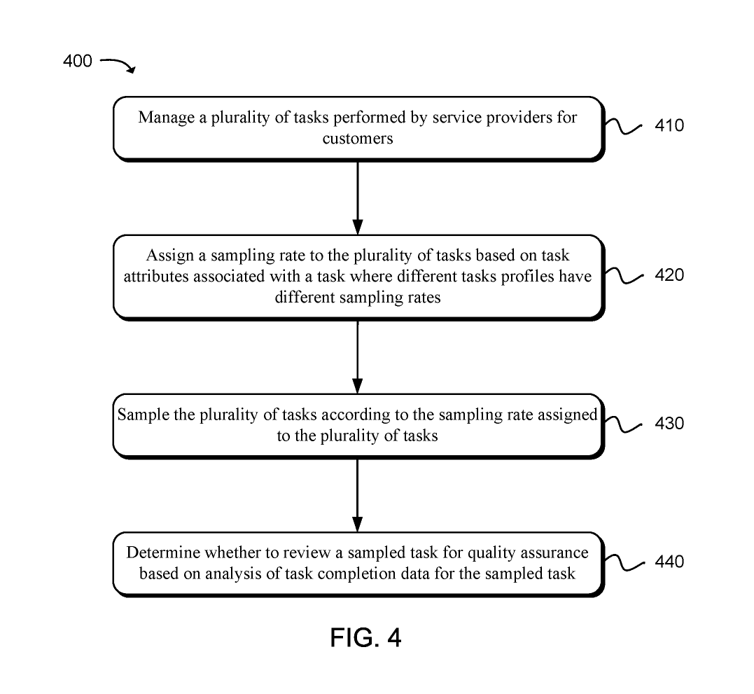

FIG. 4 illustrates an example of a method 400 for sampling tasks for quality assurance. Beginning in block 410, tasks assigned to and performed by service providers may be managed by a system that receives requests from customers to purchase a task. The system may be operated by a task seller who advertises task services to customers and then assigns a task (e.g., via a transaction) purchased by a customer to a service provider.

As in block 420, a sampling rate may be assigned to the tasks managed by the system based on task attributes associated with a task. As described earlier, task attributes for a task may include information about the task, for example, a task type, a task location, task instructions, an assigned service provider, customer information and any other information that may be related to the task. Task attributes associated with a task may be referenced when assigning a sampling rate, such that a task attribute may be used to determine a probability that a task may be performed unsuccessfully. For example, a task may be assigned a sampling rate based on a service provider assigned to the task, a geographical location where the task was performed, a customer who purchased the task, as well as other task attributes. As a specific example, tasks purchased by a customer who has a history of being dissatisfied with task performance may be assigned a higher sampling rate. Another specific example may be assigning the sampling rate based on an identification of a service provider assigned to complete the individual task (e.g., based on the reliability of the service provider as determined by a performance history). As a result of basing a sampling rate on task attributes, different tasks or task groupings may be sampled using different sampling rates.

In another example, assigning the sampling rate to tasks may be based on a predetermined anomaly sampling rate for a category of tasks. The predetermined anomaly sampling rate may indicate the likelihood that tasks within a designated category contain anomalous data in the task completion data. The anomalous data may be a variance between a task detail and the task completion data, such as a difference in a starting time logged by a service provider and a start time specified by a customer, for example. Task completion analysis may be performed for a category of completed tasks to determine a rate of occurrence of anomalous data within the respective task completion data. Based on the rate of occurrence of anomalous data, an anomaly sampling rate may be determined and the predetermined anomaly sampling rate can then be assigned to the tasks falling within the associated task category.

After assigning a sampling rate to the tasks, as in block 430, the tasks, once completed, may be sampled according to the sampling rate assigned to the tasks. Sampling the tasks may involve selecting a percentage of tasks specified by the sampling rate and then, as in block 440, determining whether to review a sampled task for quality assurance, based on analysis of task completion data for the task. For example, quality assurance rules may be applied to task completion data associated with the tasks sampled. Quality assurance rules may be used to analyze the task completion data for anomalous data in the task completion data, or in other words, analyze a task based on a quality assurance standard that includes a combination of task details and task completion guidelines. Illustratively, quality assurance rules may compare task details for a selected task to task completion data for the selected task. In cases where a task detail does not correspond with related task completion data, the task may be flagged for review.

Quality assurance rules may be tailored to various task types and/or attributes associated with a task. Examples include tailoring quality assurance rules based on task type (e.g., tailor quality assurance rules for lawn care), tailoring quality assurance rules based on geography (e.g., adjust quality assurance rules for a city according to conditions present in the city), tailoring quality assurance rules for a service provider based on service provider characteristics (e.g., rate at which a service provider completes a task). Also, quality assurance rules may be scored for effectiveness. For example, quality assurance rules may be scored based on whether the quality assurance rules accurately flag tasks having anomalous task completion data. Quality assurance rules that receive low scores can be refined in order to more accurately detect anomalies in the task completion data or the quality assurance rules can be deleted.

After applying the quality assurance rules to task completion data, resulting task analysis data may be analyzed to determine whether any anomalies were detected in the task completion data. In one example configuration, tasks having task completion data shown to contain an anomaly may be flagged. A reference to a flagged task may then be added to a task review queue. Quality assurance administrators or associates may select task references from the task review queue and perform quality assurance for the referenced tasks.

In another example configuration where anomalous quality assurance rules or non-anomalous quality assurance rules are used, tasks failing the quality assurance rules may be flagged and the tasks may be queued based on priority rules for prioritizing anomalous quality assurance rule flags and non-anomalous quality assurance rule flags. For example, priority rules for tasks flagged as satisfying anomalous quality assurance rules may be prioritized so that the task is reviewed prior to tasks flagged as satisfying non-anomalous quality assurance rules.

Based on an outcome of a review of a task, a determination may be made whether to request physical inspection of the task completion (e.g., inspect the task job site). In one example, a physical inspection of the task completion of the task may be made by an inspection service provider (e.g., a service provider employed by a task seller who specializes in task inspection or a third party inspection service). In cases where task completion for a task fails to satisfy a quality assurance standard (e.g., via quality assurance rules and/or a physical inspection), subsequent tasks may be assigned to a service provider who is different from the original service provider who performed the task. In cases where task completion for a task satisfies a quality assurance standard, but a customer is unsatisfied, subsequent task requests from the customer may be rejected.

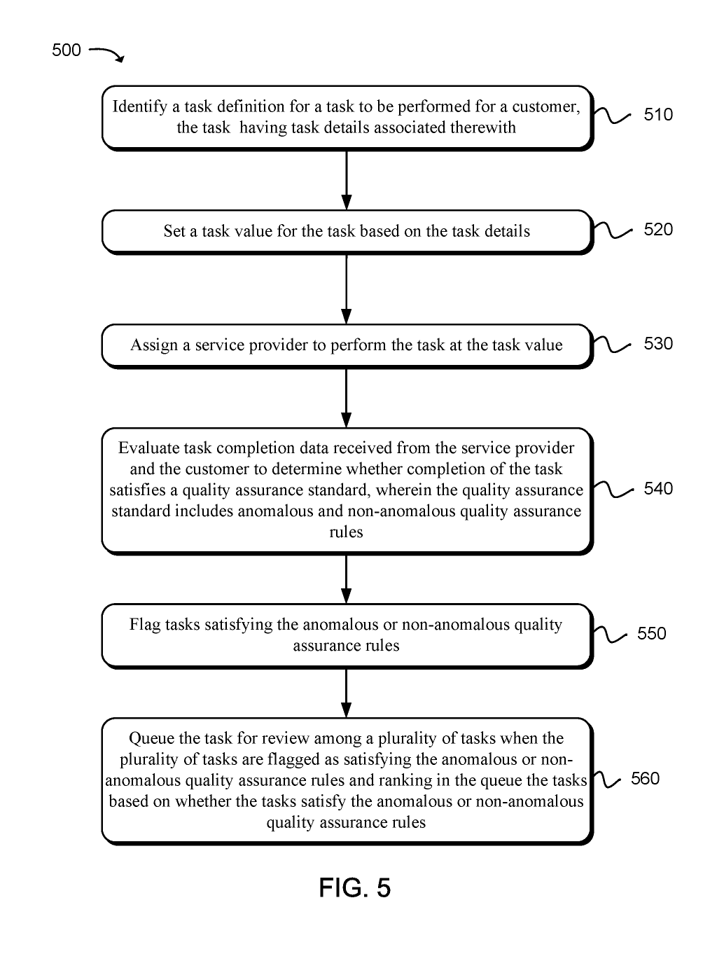

FIG. 5 illustrates an example method 500 for providing quality assurance of tasks. Beginning in block 510, a task definition for a task that is to be performed for a customer may be identified. The task may have task details that define the task. As in block 520, based on the task details, a task value may be set. For example, a task value may be a rate that a service provider may be willing to bid or pay in order to acquire the task, or a task value may be compensation that a service provider is willing to accept in order to perform the task. As in block 530, the task may be assigned to a service provider who may then perform the task at the task value.

While the service provider is performing the task, task completion data may be collected. For example, task completion data may include: geographic location data collected from the service provider to verify that the service provider has visited a task location to complete the task, photographic data for a task location that includes an ending timestamp indicating when task was completed, a task completion interval computed using a beginning timestamp and an ending timestamp for comparison to an expected task duration time, as well as any other data related to a task performed by the service provider.

Task details for tasks may be set and or updated based on statistics associated with completing a task. Over time, as statistics are collected for tasks through task completion data, task details may be refined, resulting in a more reliable benchmark with which to compare task completion data to when conducting quality assurance. As one specific example, an expected task duration time for a particular task may be based on a general estimate of how much time is needed to complete the task (i.e., by using the task details) and statistical information associated with actual completion times for performing the task. As statistical information is updated for the task, the expected task duration time may be updated.

In some cases, a service provider may arrive at a task location to find that the task details for a task do not match the conditions of the task location. In one example, a service provider may be allowed to submit a new task with a price bid for customer approval when the task details and the task value are set such that the quality assurance standard will be unsatisfied. In doing so, new task details may be submitted so that when the task completion data for the task is evaluated for quality assurance, the new task details may be used.

Once the service provider has completed the task, as in block 540, task completion data received from the service provider and the customer may be evaluated to determine whether completion of the task satisfies a quality assurance standard. In one example, the quality assurance standard may include anomalous and non-anomalous quality assurance rules. Non-anomalous quality assurance rules may be used to and evaluate task completion data for tasks selected from a general pool of tasks, whereas anomalous quality assurance rules may be used to evaluate tasks based on a predetermined sampling rate assigned to service providers and/or task attributes, as described earlier. Tasks selected may then be evaluated for quality assurance.

As in block 550, tasks satisfying the anomalous or non-anomalous quality assurance rules may be flagged and, as in block 560, the tasks may then be queued for review among a plurality of tasks when the plurality of tasks are flagged as satisfying the anomalous or non-anomalous quality assurance rules. Further, the plurality of tasks flagged as satisfying the anomalous quality assurance rules may be queued with a pool of tasks satisfying the non-anomalous quality assurance rules. A ranking in the queue may be assigned to the tasks contained in the queue based on whether the tasks satisfy the anomalous quality assurance rules or the non-anomalous quality assurance rules. Illustratively, tasks satisfying anomalous quality assurance rules may be ranked higher than tasks satisfying non-anomalous quality assurance rules, thereby placing the tasks satisfying anomalous quality assurance rules in the front of the queue where the tasks will be reviewed prior to tasks satisfying non-anomalous quality assurance rules.

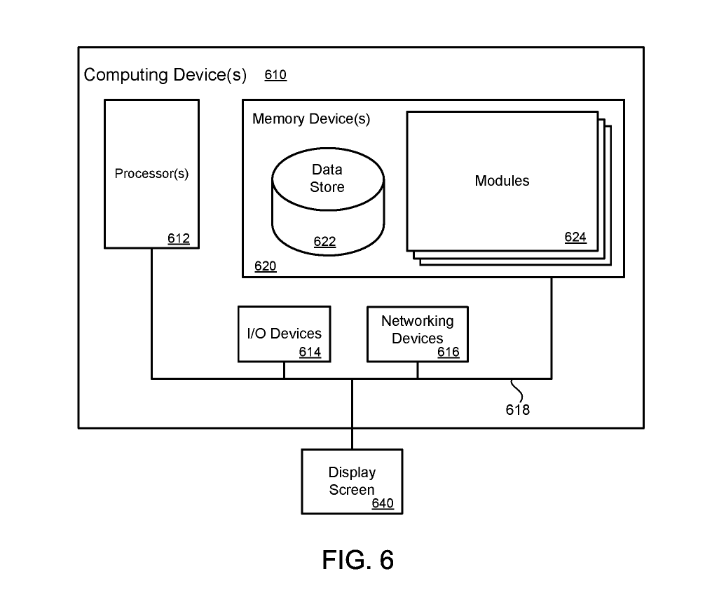

FIG. 6 illustrates an example computing device 610 on which modules of this technology may execute. A computing device 610 is illustrated on which a high level example of the technology may be executed. The computing device 610 may include one or more processors 612 that are in communication with memory devices 620. The computing device 610 may include a local communication interface 618 for the components in the computing device. For example, the local communication interface 618 may be a local data bus and/or any related address or control busses as may be desired.

The memory device 620 may contain modules that are executable by the processor(s) 612. In one example, the memory device 620 may contain a task definition module, task price module, quality assurance module, queuing module and other modules that may be located in the memory device 620. The modules 624 may execute the functions described earlier. A data store 622 may also be located in the memory device 620 for storing data related to the modules and other applications along with an operating system that is executable by the processor(s) 612.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device is a display screen 640 that is available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor(s) 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method of sampling tasks for quality assurance, comprising:
under control of a processor and memory configured with executable instructions,
managing a plurality of tasks performed by service providers for customers, using a processor;
assigning a sampling rate for the plurality of tasks based on task attributes associated with a task, wherein different tasks have different sampling rates;
sampling the plurality of tasks according to the sampling rate assigned for the plurality of tasks; and
determining whether to review a sampled task for quality assurance, using the processor, based on analysis of task completion data for the sampled task.

2. The method of claim 1, further comprising assigning the sampling rate based on a predetermined anomaly sampling rate.

3. The method of claim 2, further comprising identifying the anomaly sampling rate based on geographically defined patterns, wherein a history of similar anomalies in a geographic area is used to determine whether to sample an individual task.

4. The method of claim 2, further comprising identifying the anomaly sampling rate based on an individual service provider performance history, wherein anomalous performance history as compared with other service providers is identified using the individual service provider performance history.

5. The method of claim 1, further comprising assigning the sampling rate based on an identification of a service provider assigned to complete an individual task.

6. The method of claim 1, further comprising:
assigning the sampling rate based on anomalous quality assurance rules or non-anomalous quality assurance rules;
flagging tasks from the plurality of tasks for sampling when the task analysis data satisfies the anomalous quality assurance rules or non-anomalous quality assurance rules; and
queuing sampled tasks from the plurality of tasks based on priority rules for prioritizing anomalous sampling rule flags and non-anomalous sampling rule flags.

7. The method of claim 1, wherein the task analysis data comprises service provider profile data and assigning the sampling rate comprises assigning the sampling rate based on the service provider profile data.

8. The method of claim 7, further comprising modifying the sampling rate according to predefined modification rules when the service provider profile data changes.

9. The method of claim 1, wherein the task analysis data comprises task details, task completion guidelines, task completion data and service provider data.

10. The method of claim 1, further comprising evaluating task analysis data after task completion to determine whether the task analysis data satisfies a quality assurance standard.

11. The method of claim 10, wherein evaluating the task analysis data after the task completion further comprises receiving notification from the service provider regarding accuracy of task details prior to performing the task.

12. A task quality assurance system, comprising:
a processor;
a memory device with instructions that cause the processor to execute:
a task definition module to identify a task definition for tasks having task details to be performed for a customer;
a task price module to set a task price for the tasks based on the task details and statistical price data;
a quality assurance module to receive task completion data after task completion and to flag tasks satisfying anomalous or non-anomalous quality assurance rules for sampling the tasks; and
a queuing module to queue tasks for sampling when the tasks are flagged as satisfying the anomalous or non-anomalous quality assurance rules, wherein the tasks flagged as satisfying the anomalous quality assurance rules are queued with the tasks satisfying the non-anomalous quality assurance rules and a ranking in the queue of the tasks flagged is based on whether the tasks flagged satisfy the anomalous quality assurance rules or the non-anomalous quality assurance rules.

13. The system of claim 12, wherein the quality assurance module receives notification from the customer regarding fulfillment of task requirements by a service provider after the task completion.

14. A method for providing assurance of tasks, comprising:
under control of a processor and memory configured with executable instructions,
identifying a task definition for a task to be performed for a customer, the task having task details associated therewith;
setting a task value for the task based on the task details, using the processor;
assigning a service provider to perform the task at the task value, using the processor;
evaluating task completion data received from the service provider and the customer to determine whether completion of the task satisfies a quality assurance standard, using the processor, wherein the quality assurance standard includes anomalous and non-anomalous quality assurance rules;
flagging tasks satisfying the anomalous or non-anomalous quality assurance rules; and
queuing the task for review among a plurality of tasks when the plurality of tasks are flagged as satisfying the anomalous or non-anomalous quality assurance rules, and the plurality of tasks flagged as satisfying the anomalous quality assurance rules are queued with the plurality of tasks satisfying the non-anomalous quality assurance rules and a ranking in the queue of the tasks flagged is based on whether the plurality of tasks flagged satisfy the anomalous quality assurance rules or the non-anomalous quality assurance rules.

15. The method of claim 14, further comprising collecting geographic location data from the service provider to verify the service provider has visited a task location to complete the task.

16. The method of claim 14, further comprising acquiring photographic data with an ending timestamp for a task location after the task is performed as part of the task completion data.

17. The method of claim 14, further comprising computing a task completion interval using a beginning timestamp and an ending timestamp for comparison to an expected task duration time.

18. The method as in claim 17, further comprising obtaining the expected task duration time using the task details and statistical information associated with the task and task details.

19. The method as in claim 18, further comprising updating the expected task duration time as the statistical information is updated.

20. The method as in claim 14, further comprising allowing a service provider to submit a new task with a price bid for customer approval when the task details and the task value are set such that the quality assurance standard will be unsatisfied.
